(19) United States
(12) Patent Application Publication
(10) Pub. No.: US 2025/0140902 A1
(43) Pub. Date: May 1, 2025

(54) CELLULOSE-BASED ALL-SOLID-STATE POLYMER ELECTROLYTE SEPARATOR, PREPARATION METHOD THEREFOR AND APPLICATION THEREOF

(71) Applicants: BattFlex Technological, Inc., Wuhan (CN); EneRol Nanotechnologies, Inc, Ningbo (CN); Jianghan University, Wuhan (CN)

(72) Inventors: Ming XIE, Wuhan (CN); Xuanxuan ZHANG, Ningbo (CN); Zhihong LIU, Ningbo (CN); Zhaohuai LI, Wuhan (CN)

(73) Assignees: BattFlex Technological, Inc., Wuhan (CN); EneRol Nanotechnologies, Inc, Ningbo (CN); Jianghan University, Wuhan (CN)

(21) Appl. No.: 18/932,639

(22) Filed: Oct. 31, 2024

(30) Foreign Application Priority Data
Nov. 1, 2023 (CN) 202311441923.6

(51) Int. Cl. H01M 10/056; H01M 50/429; H01M 50/431; H01M 50/451

(52) U.S. Cl. CPC H01M 10/056; H01M 50/4295; H01M 50/431; H01M 50/451; H01M 2300/0065; H01M 2300/0094

(57) ABSTRACT

A cellulose-based all-solid-state polymer electrolyte separator, a preparation method thereof and an application thereof are provided. The cellulose separator is used as a skeleton, and solid-state polymer electrolyte is injected into pores of the separator using atomic layer deposition and dipping-coating processes. In addition, the polymer electrolyte remains in an amorphous structure at high temperatures by using an instantaneous quenching method, and ionic conductivity of the solid-state polymer electrolyte at room temperature is improved. After a surface of the solid-state polymer electrolyte separator is further coated with an alumina nanolayer, an electrochemical window width of the separator is significantly increased, and the solid-state polymer electrolyte separator is prevented from decomposing under a high voltage.

### CROSS REFERENCE TO THE RELATED APPLICATIONS

This application is based upon and claims priority to Chinese Patent Application No. 202311441923.6, filed on Nov. 1, 2023, the entire contents of which are incorporated herein by reference.

### TECHNICAL FIELD

The present disclosure belongs to the technical field of battery materials, and particularly relates to a cellulose-based all-solid-state polymer electrolyte separator, a preparation method therefor and an application thereof.

### BACKGROUND

As an energy storage device, a lithium-ion battery plays a crucial role in the renewable energy industry. However, the lithium-ion battery now faces more and more safety problems due to leakage, flammability, and poor chemical stability of liquid electrolyte, which also attracts more and more attention of people. In order to solve the problems, researchers have replaced organic liquid electrolytes with solid-state electrolytes to prepare solid-state lithium batteries, safety and energy density of the batteries are accordingly improved.

The solid-state electrolytes can be divided into solid-state oxide electrolytes, solid-state sulfide electrolytes, gel electrolytes, polymer solid-state electrolytes, and composite solid-state electrolytes, among which the composite solid-state electrolytes take into account the advantages of inorganic electrolytes, such as high ionic conductivity and strong chemical stability, and easy large-scale production and low interfacial resistance of polymer electrolytes.

Common polymers include polyethylene oxide (PEO), polymethyl methacrylate (PMMA), polyacrylonitrile (PAN), poly(ethylene carbonate) (PEC), polypropylene carbonate (PPC), polyvinylidene fluoride (PVDF), and polyvinylidene fluoride-hexafluoropropylene (PVDF-HFP), and the like. A solid-state polymer lithium-ion battery has the following advantages: (1) a separator and liquid electrolyte can be replaced, and mass is accordingly reduced: (2) leakage problem is solved: (3) it exhibits high decomposition temperature and good safety: (4) it has relatively high mechanical strength, which prevents the growth of lithium dendrite to some extent: (5) it exhibits good flexibility, allowing for the preparation of flexible batteries that are capable of withstanding external forces and deformations to some extent during operation: (6) it has simple preparation process; and (7) it offers good controllability and can be used for preparing batteries of specific shapes and sizes. However, the solid-state polymer electrolytes also face some problems: (1) the polymer electrolyte is still insufficient to suppress dendrites, and mechanical strength thereof needs to be further improved: (2) the ionic conductivity of lithium ions is relatively low; especially at room temperature; and (3) the stability of electrochemical window is low; making it unable to be widely used and promoted.

PEO is the only solid-state polymer electrolyte that has commercialized and is also the most researched solid-state polymer electrolyte. However, PEO has a relatively high crystallinity, with ionic conductivity at room temperature about 10⁻⁶ S/cm, and it can only operate at a temperature ≤60° C., making it difficult to meet the application at room temperature. In addition, an electrochemical window of PEO-based solid-state polymer electrolyte is narrow; making it unsuitable for being used with high-voltage cathode material. The Chinese Patents CN 110669214A, CN112993396A, and CN112687949A describe that the ionic conductivity at room temperature of PEO-based solid-state electrolytes designed by modifying PEO through grafting, copolymerization, crosslinking and other modification methods remains low (4.5×10⁻⁴ S/cm). Common modification methods involve complex synthesis processes and stringent conditions, but low yields, making them unable to meet normal operation requirements of solid-state batteries at room temperature. The ionic conductivity at room temperature can also be improved by blending and modifying the PEO-based solid-state electrolyte, but additional additives that require high preparation costs and are difficult to be obtained are required.

“Zhang W, Nie J, Li F, et al. A Durable and Safe Solid-State Lithium Battery with a Hybrid Electrolyte Membrane [J]. Nano Energy, 2018, 45, 413-419” introduces that polyvinylidene fluoride-hexafluoropropylene (PVDF-HFP) is a copolymer formed by introducing functional groups, such as hexafluoropropylene (HFP), into a PVDF chain, which improves the ionic conductivity at room temperature. However, the ionic conductivity of PVDF-HFP solid-state electrolyte can only reach 7.63×10⁻⁴ S/cm at a high temperature of 100° C. only after liquid electrolyte and lithium salt have infiltrated into the membrane, while the ionic conductivity of PVDF-HFP solid-state electrolyte membrane that has been infiltrated with the liquid electrolyte and lithium salt at room temperature is only 1.1×10⁻⁴ S/cm.

Polyacrylonitrile (PAN) is an expensive synthetic polymer that has not yet been commercialized, while polymethyl methacrylate (PMMA)-based solid-state electrolyte faces the problems of high brittleness and low ionic conductivity at room temperature.

In order to improve the ionic conductivity of solid-state polymer electrolytes, researchers have taken various technical means. A common method is to dope metal oxides to improve the conductivity of lithium ions. In addition, the solid-state polymer electrolytes can be modified to improve the ionic conductivity by means of blending, blocking, grafting, and adding plasticizers or fillers. However, the technical means are relatively complex, and the ionic conductivity at room temperature remains 1-2 orders of magnitude lower than that at high temperatures.

Polyethylene oxide (PEO) is primary material for preparing the solid-state polymer electrolytes, and the ionic conductivity thereof is mainly sourced from electrostatic coupling between a lone pair of electrons on oxygen atoms and Li⁺ in an amorphous region of a PEO chain, which increases solvation effects of Li⁺. Therefore, Li⁺ can migrate through continuous complexation and decomplexation reactions between ether oxygen atoms in the PEO chain, which is similar to a manner of movements of H⁺ in water. Reducing the crystallinity of PEO (that is, increasing the amorphous region) is an important means to effectively improve the ionic conductivity of solid-state polymer electrolytes. At present, introducing a side chain and increasing a degree of branching in the solid-state polymer electrolytes are key measures to reduce the crystallinity of PEO and improve the ionic conductivity. However, overly prioritizing the flexibility of PEO will inevitably sacrifice the mechanical properties of solid-state polymer electrolytes, thereby greatly increasing the risk of lithium dendrite puncture, which is not conducive to ensuring the safety performance of the battery. In the prior art, in order to improve the ionic conductivity and mechanical strength of solid-state electrolytes, composite solid-state electrolyte composed of inorganic fillers and polymer substrates are formed by doping the polymer with more than one-dimensional ceramic-based nanowires/networks, which is considered to be one of the most promising candidate electrolyte for an all-solid-state lithium battery. However, complex treatment process and inherent brittleness of ceramic material make it difficult to be promoted and used for the solid-state electrolytes. Therefore, it is imperative to develop solid-state polymer electrolyte with both high ionic conductivity and excellent mechanical strength.

Inorganic solid-state electrolytes, such as lithium lanthanum zirconate (LLZO) represented by garnet-based hybrid solid electrolyte (Li₇La₃Zr₂O₁₂), exhibit high ionic conductivity and excellent stability with lithium; and the Chinese Patent CN108365262A provides a method for improving the ionic conductivity by mixing LLZO particles into solid-state polymer electrolyte; however, the ionic conductivity of the resulting solid-state electrolyte remains below 3.68×10⁻⁵ S/cm, and a thickness of the solid-state electrolyte film prepared by the method is greater than 100 microns. The Chinese Patent CN116190770A provides a garnet-type solid-state electrolyte film, but the ionic conductivity is 1×10⁻⁴S/cm×10⁻⁶S/cm, which is lower than that of PVDF-HFP solid-state electrolyte separator. In addition, high-temperature annealing is required for the preparation to increase density and ionic conductivity, therefore, the garnet-type solid-state electrolyte film is unable to be attached onto the polymer electrolyte to form a film with high ionic conductivity. The garnet-type solid-state electrolyte film prepared according to the method has a thickness greater than 50 microns. Such a high thickness not only reduces the energy density of the battery but also seriously increases an internal resistance of the battery, making it unfavorable for building an energy storage system based on solid-state electrolytes.

### SUMMARY

In order to solve the problem of low ionic conductivity of PEO-based solid-state polymer electrolyte at room temperature, the present disclosure provides a cellulose-based all-solid-state polymer electrolyte separator, a preparation method therefor and an application thereof, where the cellulose separator is used as a skeleton, and solid-state polymer electrolyte is injected into pores of the separator using atomic layer deposition and dipping-coating processes. In addition, the polymer electrolyte remains in an amorphous structure at high temperatures by using an instantaneous quenching method, and the ionic conductivity of the solid-state polymer electrolyte at room temperature is improved. After a surface of the solid-state polymer electrolyte separator in the present disclosure is further coated with an alumina nanolayer, an electrochemical window width of the separator is significantly increased, and the solid-state polymer electrolyte separator is prevented from decomposing under a high voltage.

A cellulose-based all-solid-state polymer electrolyte separator, including a three-dimensional polymer skeleton and a polymer electrolyte: where a surface and inner pores of the three-dimensional polymer skeleton are coated with an inorganic oxide nanolayer: the polymer electrolyte includes a lithium salt and a polymer matrix, the polymer electrolyte is filled in the three-dimensional polymer skeleton coated with the inorganic oxide nanolayer, and is heated to 60° C.-120° C. and vacuum dried to obtain a precursor of the cellulose-based all-solid-state polymer electrolyte separator, the precursor is rapidly frozen and quenched to obtain the cellulose-based all-solid-state polymer electrolyte separator.

The three-dimensional polymer skeleton is a three-dimensional interconnected network structure interwoven by a polyethylene (PE) lithium battery separator, or a polypropylene (PP) lithium battery separator, or nanocellulose or multi-dendritic cellulose, with a diameter of the nanocellulose or multi-dendritic cellulose at a nanoscale or a submicron scale: the inorganic oxide nanolayer is selected from one or more of aluminum oxide, titanium oxide, silicon oxide, lithium oxide, and oxides of lithium/lanthanum/zirconium; the lithium salt is selected from at least one of LiPF₆, LiBF₄, lithium perfluoroalkyl sulfonimide lithium salts, lithium borate complexes, lithium phosphate complexes, and lithium aluminate; and the polymer matrix is selected from at least one of polyethylene oxide or modified substances thereof, polyacrylonitrile or modified substances thereof, polymethyl methacrylate or modified substances thereof, poly(ethylene carbonate) or modified substances thereof, polyvinylidene fluoride or modified substances thereof, polycarbonate or modified substances thereof, polysiloxane or modified substances thereof, or succinonitrile or modified substances thereof.

The three-dimensional interconnected network structure interwoven by a PE lithium battery separator, or a PP lithium battery separator, or nanocellulose or multi-dendritic cellulose has a thickness of 10-30 microns, with a pore size within a range of 100-200 nm.

The present disclosure further provides a preparation method for the cellulose-based all-solid-state polymer electrolyte separator, including the following steps:
S1. preparing the three-dimensional polymer skeleton;
S2. depositing the inorganic oxide nanolayer on the three-dimensional polymer skeleton using atomic layer deposition technology;
S3. filling the polymer electrolyte in the three-dimensional polymer skeleton coated with the inorganic oxide nanolayer, and heating for curing; and
S4. performing a quenching treatment.

Further, the three-dimensional polymer skeleton in the S1 is subjected to a surface treatment, where the surface treatment includes pre-treatment by ozone oxidation under vacuum or electron irradiation, the three-dimensional polymer skeleton mainly consists of nanocellulose, or a PE lithium battery separator, or a PP lithium battery separator, and the PE lithium battery separator or the PP lithium battery separator has a thickness of 10-30 microns, with a pore size within a range of 100-300 nm.

Further, the cellulose separator in S2 is subjected to atomic layer deposition of an oxide layer, including:
S21. placing the three-dimensional polymer skeleton in an atomic layer deposition device;
S22. introducing an inert carrier gas into the atomic layer deposition device and evacuating the atomic layer deposition device, adjusting to make a pressure inside a reaction chamber lower than 0.01 atm, and to make a temperature inside the reaction chamber up to 25-200° C.; and
S23. repeatedly and alternately injecting a first gas-phase precursor and an oxygen source vapor into the reaction chamber, such that the first gas-phase precursor and the oxygen source vapor react to form an inorganic oxide, where the inorganic oxide is deposited layer by layer on the surface and the inner pores of the three-dimensional polymer skeleton, and a residual gas in the reaction chamber is replaced with the inert carrier gas.

Further, the first gas-phase precursor is selected from one or a mixture of volatile silicon ions, metal alkylamino salts, metal organic compounds, halides, alkoxides, or metal β-diketone complexes, where metal ions in the metal alkylamino salts, the metal organic compounds, the halides, the alkoxides, or the metal β-diketone complexes are aluminum, titanium, lithium, lanthanum, or zirconium ions, and the inert carrier gas is selected from nitrogen, helium, or argon; and the oxygen source vapor is selected from one of deionized water, hydrogen peroxide, oxygen, ozone, or atomic oxygen.

Further, the S3 includes: immersing the cellulose separator treated in the S2 into a polymer electrolyte solution, scraping the polymer electrolyte solution on the three-dimensional polymer skeleton evenly, and then placing in a vacuum oven for drying to obtain the precursor of the cellulose-based all-solid-state polymer electrolyte separator.

A mass ratio of the polymer matrix to the lithium salt in the polymer electrolyte solution is (20:1)-(1:1), and a polymer concentration in a solvent is 0.1-10 g·mL⁻¹; and the solvent of the polymer electrolyte solution is selected from one or more of N-dimethylformamide, acetonitrile, N-methylpyrrolidone, dimethyl sulfoxide, or dichloromethane.

A solid-state battery, including the cellulose-based all-solid-state polymer electrolyte separator or the cellulose-based all-solid-state polymer electrolyte separator prepared by the preparation method for the cellulose-based all-solid-state polymer electrolyte separator.

Compared with the prior art, the present disclosure has the beneficial effects as follows:

1. By using a cellulose separator as a skeleton and uniformly growing an oxide layer on a surface thereof, the present disclosure does not need to perform a dispersion processing after oxide nanoparticles are added, thereby simplifying the preparation process and improving production efficiency. In addition, it is difficult for traditional methods to achieve uniform dispersion when oxide ceramics are added to polymer electrolytes. In the present disclosure, the cellulose is interwoven into a network and filled with the polymer electrolyte after the oxides are deposited on the surface of the cellulose, and the cellulose network forms a mesh path for ion conduction, such that the ionic conductivity is improved.

2. By adopting the dipping-coating process, the solid-state polymer electrolyte is injected into the pores of the cellulose separator, such that a more uniform distribution and a higher filling degree can be achieved. Traditional ways of adding oxides involve mixing the oxides into the electrolyte solution for stirring, and then coating them onto the electrodes, resulting in sedimentation and non-uniformity of the oxides; furthermore, the oxide particles are discontinuous, and the ionic conductivity is low. Compared with the traditional ways of adding fillers, the present disclosure first deposits the oxides on the surface of cellulose, and then directly coats the electrolyte solution, such that the oxides are more evenly dispersed, the cellulose is continuous structure, and the ionic conductivity is improved.

3. By heating the separator above 60° C. and then performing instantaneous quenching, the polymer electrolyte in the present disclosure can remain in the high-temperature amorphous state even at room temperature, further improving the ionic conductivity of the solid-state polymer electrolyte at room temperature. Compared with the complex treatment means of traditional technology, the present disclosure has simpler treatment process and is more cost-effective.

4. The porous mesh separator in the present disclosure has a thickness of 10-30 microns. After the metal oxides are deposited, the thickness increases by only 1-100 nm. The cellulose separator, after being coated with the solid-state polymer electrolyte, is evenly scraped by a scraper at a distance of 20-1000 μm away from the cellulose separator, and the thickness of the cellulose separator can still be controlled to be 20-30 microns.

### BRIEF DESCRIPTION OF THE DRAWINGS

In order to more clearly illustrate technical solutions in the specific implementations of the present disclosure or in the prior art, a brief introduction to the accompanying drawings required for the description of the specific implementations or the prior art will be provided below. Obviously, the accompanying drawings in the following description are some of the implementations of the present disclosure, and those of ordinary skill in the art may still derive other drawings from these accompanying drawings without any creative effort.

FIG. 1 shows a scanning electron microscope image of the cellulose separator deposited with 1 nm of aluminum oxide.

FIG. 2 shows a scanning electron microscope image of a composite PEO-coated cellulose separator deposited with 1 nm of aluminum oxide.

FIG. 3 is shows XRD patterns of PEO electrolyte crystal, an unquenched solid-state polymer electrolyte separator prepared in the step 3 of Example 1, and a solid-state polymer electrolyte separator quenched in the step 4 of Example 1 at different temperatures.

### DETAILED DESCRIPTION OF THE EMBODIMENTS

In order to make the objectives, technical solutions and technical effects of the embodiments of the present disclosure clearer, the technical solutions of the embodiments of the present disclosure will be described clearly and completely, and the embodiments described below are some, but not all, embodiments of the present disclosure. On the basis of the embodiments of the present disclosure, all other embodiments obtained by a person of ordinary skill in the art without making creative efforts shall fall within the scope of protection of the present disclosure.

It should be understood that the weights of relevant components stated in the embodiments of the present disclosure not only refer to specific content of each component, but may also represent the proportional relationship between the weights of the components. Therefore, any proportional increase or reduce based on the content of the components in the embodiments of the present disclosure shall fall within the scope disclosed in the specification of the present disclosure. Specifically, the weights in the embodiments of the present disclosure can be the mass units commonly known in the chemical field, such as μg, mg, g, and kg.

For experimental steps or conditions not specifically indicated in the embodiments, the conventional experimental steps or conditions described in the literature of the field can be followed. Reagents or instruments used without indicating manufacturers are conventional products commercially available.

The embodiments of the present disclosure provide a cellulose-based all-solid-state polymer electrolyte separator, including a three-dimensional polymer skeleton, an inorganic oxide nanolayer deposited on a surface of and inner pores of the three-dimensional polymer skeleton, and a polymer electrolyte, where the polymer electrolyte includes a lithium salt and a polymer matrix, which is filled inside the three-dimensional polymer skeleton coated with the inorganic oxide nanolayer.

The three-dimensional polymer skeleton is a three-dimensional interconnected network structure interwoven by nanocellulose or multi-dendritic cellulose, with a diameter of the cellulose at a nanoscale or a submicron scale: the inorganic oxide nanolayer is selected from one or more of aluminum oxide, titanium oxide, silicon oxide, lithium oxide, and oxides of lithium/lanthanum/zirconium: the lithium salt is selected from at least one of LiPF₆, LiBF₄, lithium perfluoroalkyl sulfonimide lithium salts, lithium borate complexes, lithium phosphate complexes, and lithium aluminate; the polymer matrix is selected from at least one of polyethylene oxide or modified substances thereof, polyacrylonitrile or modified substances thereof, polymethyl methacrylate or modified substances thereof, polyvinyl chloride or modified substances thereof, polyvinylidene fluoride or modified substances thereof, polycarbonate or modified substances thereof, polysiloxane or modified substances thereof, or succinonitrile or modified substances thereof; and the cellulose separator is instantaneously quenched by liquid nitrogen or other methods by heating the cellulose-based all-solid-state polymer electrolyte to above 60° C.

The three-dimensional interconnected network structure formed by the cellulose can effectively enhance the mechanical strength of the solid-state polymer electrolyte, inorganic oxide on a surface of the cellulose can effectively make lithium ions being complexed, thereby providing continuous channels and ion anchoring sites for ion transmission and transition, and promoting ion migration, such that the ionic conductivity of the solid-state polymer electrolyte is improved. In addition, the oxide has oxygen vacancies that have an adsorption effect on oxygen atoms, and can cross-link with polymer chains, which disrupts an orderly arrangement of polymer segments, reduces crystallinity of the electrolyte, and improves the conductivity. Since the inorganic oxide nanolayer formed by atomic deposition is uniformly distributed in the three-dimensional skeleton matrix and on the surface thereof, it has a large specific surface area, facilitating the migration of Lit. Metal ions in the lithium salt filled within the pores of the three-dimensional skeleton matrix can be complexed with oxygen atoms in the polymer, which further improves the ionic conductivity of the solid-state polymer electrolyte.

The solid-state polymer electrolyte in the present disclosure has high ionic conductivity with excellent mechanical strength. It not only exhibits high efficiency in ion migration and transmission, but also possesses high mechanical strength, good toughness, and high compressive strength, such that the solid-state polymer electrolyte can resist the risk of puncture of lithium dendrites in the battery, and the safety performance of the battery is improved.

The present disclosure further provides a preparation method for the cellulose-based all-solid-state polymer electrolyte separator, including the following steps:

### (1) Preparation of the Cellulose Separator

Select a cellulose separator with a certain pore size and suitable for being used as a skeleton, and perform surface treatment to improve the reactivity of the cellulose fiber.

The cellulose separator is purchased from EneRol Nanotechnologies, Inc., and is mainly made from cellulose nanofiber, and the separator has a thickness about 10-30 microns, with a pore size within a range of 100-200 nm. The separator has been widely used in supercapacitors, has been published in the Chinese Patents CN107230764A, CN107221628A, CN206465588U, CN207217639U, and CN211743278U, and the cellulose separator can also be the lithium battery separator disclosed in the above patents.

The surface treatment mainly involves pre-treatment of the cellulose separator by ozone oxidation under vacuum or electron irradiation.

### (2) Atomic Layer Deposition of Oxide on the Cellulose Separator

Place the prepared cellulose separator into an atomic layer deposition device for atomic layer deposition, such that oxide can grow uniformly on a surface of the cellulose fibers, specifically including the following steps:
step 21, place the prepared cellulose separator into an atomic layer deposition device for atomic layer deposition;
step 22, introduce inert carrier gas into the atomic layer deposition device and evacuate the device, adjust an outlet valve of a reaction chamber of the device to make the pressure inside the reaction chamber lower than 0.01 atm; and heat the device to make a deposition temperature being 25-200° C.; and
since the separator is not resistant to high temperature, the deposition temperature is lowered in the step;
step 23, inject a first gas-phase precursor into the reaction chamber for 0.1-1000 s: introduce inert carrier gas to flush out the excess first gas-phase precursor and byproducts for 1-800 s: inject oxygen source vapor into the reaction chamber to react with the first gas-phase precursor adsorbed on a surface of the matrix, and deposit reaction products on a surface of the matrix to be coated or 0.1-1000 s; and introduce inert carrier gas again to flush out the unreacted oxygen source vapor and byproducts for 1-800 s; and
step 24, repeat the step 23 in cycles, set a desired number of cycles until a thickness of the deposited surface modification material reaches 1 nm; and preferably, a thickness of the oxide is 1-100 nm, or 1-50 nm.

The inert carrier gas is selected from nitrogen, helium, or argon.

The first gas-phase precursor is selected from one or a mixture of volatile silicon ions, metal alkylamino salts, metal organic compounds, halides, alkoxides, or metal β-diketone complexes, where metal ions in the metal alkylamino salts, the metal organic compounds, the halides, the alkoxides, or the metal β-diketone complexes are aluminum, titanium, lithium, lanthanum, or zirconium ions.

The oxygen source vapor is selected from one of deionized water, hydrogen peroxide, oxygen, ozone, or atomic oxygen.

### (3) Dipping and Coating of the Solid-State Polymer Electrolyte

Prepare a solid-state polymer electrolyte solution, that is, fully mix and disperse the polymer electrolyte in a solvent at a high speed to obtain the solid-state polymer electrolyte solution;
immerse the cellulose separator treated in the step (2) into the solid-state polymer electrolyte solution, to make the polymer electrolyte infiltrated into pores of the cellulose separator; and
take out the infiltrated cellulose separator and adjust a distance between a scraper and the cellulose separator to 20-1000 μm, scrape the solution on the cellulose separator to form a film; and place the film in a vacuum oven at 60-120° C. for 6-48 h to obtain a precursor of the solid-state polymer electrolyte separator.

As one of the embodiments, the polymer electrolyte solution in the step (3) is an organic solvent in which a polymer and lithium salt are dissolved, a mass ratio of the polymer to the lithium salt is (20:1)-(1:1), and a polymer concentration in the solvent is 0.1-10 g·mL⁻¹; and the solvent of the polymer solution is selected from one or more of N,N-dimethylformamide, acetonitrile, N-methylpyrrolidone, dimethyl sulfoxide, or dichloromethane.

As one of the embodiments, the polymer is PEO, the lithium salt is LiDFOB, the solvent is acetonitrile, and a mass ratio of the PEO to the LiDFOB is 5:1, and a concentration of the PEO in acetonitrile is 2 g·mL⁻¹.

### (4) Heating and Quenching Treatment

Heat the cellulose separator dipped and coated with the solid-state polymer electrolyte in the step (3) to above 60° C. to make the solid-state polymer electrolyte presents an amorphous state. Perform instantaneous quenching of the cellulose separator by liquid nitrogen or other means to ensure that the polymer electrolyte remains in the high-temperature amorphous state even at room temperature.

The preparation method for a flexible solid-state electrolyte separator provided by the present disclosure has a simple process and a short production cycle, requires no complex equipment, and is easy to realize mass production. The flexible solid-state electrolyte separator prepared by the present disclosure combines the cellulose separator with the solid-state polymer electrolyte, thereby achieving the purpose of improving the ionic conductivity of the solid-state polymer electrolyte at room temperature. The present disclosure not only simplifies the processing means but also effectively improves the performance of the solid-state polymer electrolyte.

For the all-solid-state electrolyte separator after being treated in the step (4), a layer of aluminum oxide of 1 nm is further deposited on the surface of the solid-state electrolyte separator using ALD technology, which can make the PEO resistant to a high voltage.

The embodiments of the present disclosure further provide a solid-state battery; which includes the above solid-state polymer electrolyte, or the solid-state polymer electrolyte prepared by the above method.

Since the solid-state battery provided by the embodiments of the present disclosure contains the solid-state polymer electrolyte with high ionic conductivity and strong mechanical strength, the solid-state polymer electrolyte can resist the risk of puncture of lithium dendrites in the battery, and the safety performance and energy density of the battery are improved.

A positive electrode, a negative electrode, a separator, and other components in the solid-state battery of the embodiments of the present disclosure can be made from any materials that meet actual application requirements, and the embodiments of the present disclosure do not specifically limit the functional materials.

In order to enable those skilled in the art to clearly understand the implementation details and operations of the present disclosure, and to demonstrate the significant improvement in performance of the solid-state polymer electrolyte and the solid-state battery of the present disclosure, the following various examples are provided to illustrate the above technical solutions.

### Example 1

### (1) Preparation of the Cellulose Separator

The cellulose separator was purchased from EneRol Nanotechnologies, Inc., and was mainly made from cellulose nanofiber, and the separator had a thickness about 10-30 microns, with a pore size within a range of 100-200 nm; and

the cellulose separator was placed in a vacuum chamber for ozone oxidation pretreatment at a reaction temperature of 50° C. for 30 min.

### (2) Atomic Layer Deposition of Oxide on the Cellulose Separator

A surface of the pretreated cellulose separator and surfaces inside holes thereof were coated with aluminum oxide using atomic layer deposition (ALD) technology, a reaction temperature was 80° C., and a coating was deposited for 10 cycles (a thickness of the aluminum oxide with 10 cycles was about 1 nm), and specifically including:
step 21, the prepared cellulose separator was placed into an atomic layer deposition device for atomic layer deposition;
step 22, inert carrier gas was introduced into the atomic layer deposition device and the device was evacuated, an outlet valve of a reaction chamber of the device was adjusted to make the pressure inside the reaction chamber lower than 0.01 atm; and the device was heated to make a deposition temperature being 100° C.; and
since the separator is not resistant to high temperature, the deposition temperature is lowered in the step;
step 23, trimethylaluminum was injected into the reaction chamber for 5 s and kept for 180 s; inert carrier gas was introduced to flush out the excess trimethylaluminum and byproducts for 30 s; water was injected into the reaction chamber to react with the trimethylaluminum adsorbed on a surface of the matrix, and deposit reaction products on a surface of the matrix to be coated or 180 s; and inert carrier gas was introduced again to flush out the unreacted oxygen source vapor and byproducts for 30 s; and
step 24, the step 23 was repeated in cycles, and a desired number of cycles was set to 10 until a thickness of the deposited surface modification material reached 1 nm. The inert carrier gas was selected from nitrogen, helium, or argon.

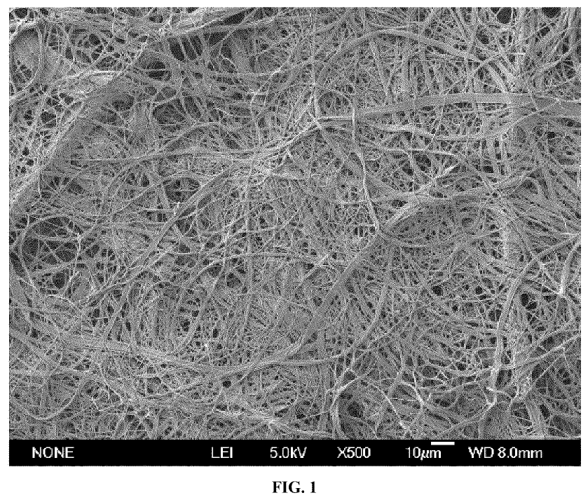

FIG. 1 shows a scanning electron microscope image of the cellulose separator deposited with 1 nm of aluminum oxide.

### (3) Dipping and Coating of the Solid-State Polymer Electrolyte

Preparing the polymer electrolyte solution: polyethylene oxide (PEO) and lithium difluoro (oxalato) borate (LiDFOB) were mixed in a mass ratio of 5:1, and then dissolved in acetonitrile, and a total concentration of the polymer and lithium salt was adjusted to 2 g·mL⁻¹:

the cellulose separator treated in the step (2) was immersed into the solid-state polymer electrolyte solution, to make the polymer electrolyte infiltrated into pores of the cellulose separator; and

the infiltrated cellulose separator was taken out, and a distance between a scraper and the cellulose separator was adjusted to 20-1000 μm, the solution on the cellulose separator was scraped to form a film; and place the film in a vacuum oven at 60-120° C. for 6-48 h to obtain the solid-state polymer electrolyte separator.

### (4) Heating and Quenching Treatment

The cellulose separator dipped and coated with the solid-state polymer electrolyte in the step (3) was heated to 60° C.-100° C. to make the solid-state polymer electrolyte presents an amorphous state; and instantaneous quenching of the cellulose separator was performed by liquid nitrogen or other means to ensure that the polymer electrolyte remained in the high-temperature amorphous state even at room temperature.

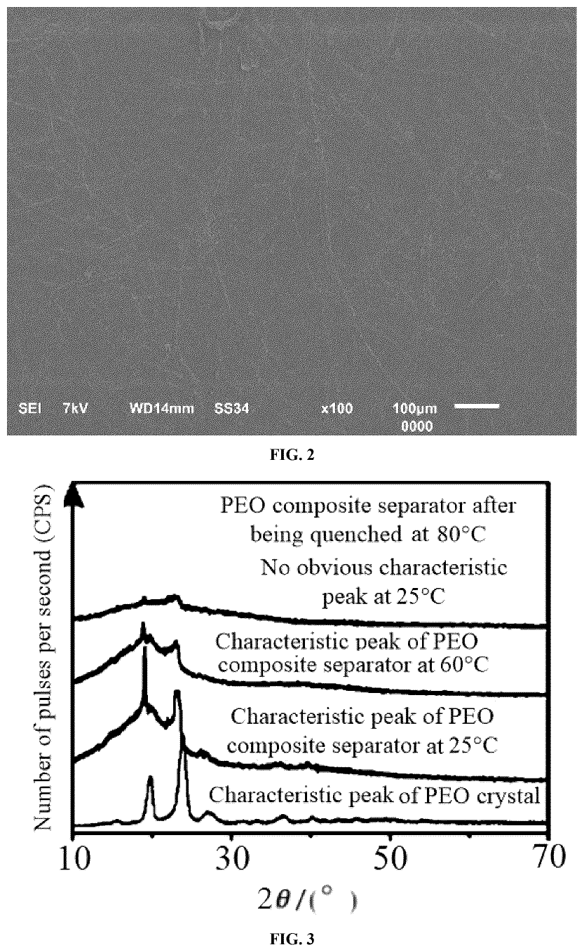

FIG. 2 shows a scanning electron microscope image of a composite PEO-coated cellulose separator deposited with 1 nm of aluminum oxide.

### Example 2

### (1) Preparation of a Porous Mesh Separator

A PE lithium battery separator was selected, and the PE lithium battery separator could be either a wet-process separator or a dry-process separator: a preparation method for the wet-process separator involved the addition of a low molecular-weight additives as pore-forming agents to polyethylene and other polymer materials for stretching, and a microporous membrane was then prepared using a solvent to extract small molecules. The preparation method can be found in relevant patents, including U.S. Pat. No. 5,051,183A (1991), U.S. Pat. No. 5,503,791A (1996) and JP.2003292665A; and the dry-process uniaxial stretching was performed to prepare a lithium-ion battery separator by using a difference between a crystalline region and an amorphous regions of crystalline polymer material, which was disclosed in the patents, such as U.S. Pat. No. 3,558,764A (1971). A method of the dry-process uniaxial stretching for preparing the microporous membrane included three steps: (a) a precursor film with a parallel lamellar structure under stress-induced conditions was performed; (b) the precursor film was subjected to heat treatment to eliminate defects and increase a lamellar thickness; and (c) two-step stretching was performed, that is, cold stretching was performed to induce the formation of micropores, and hot stretching was performed to make a size of micropores increased continuously. The PE separator had a thickness about 10-30 microns, with a pore size within a range of 100-200 nm; and

the separator was placed in a vacuum chamber for ozone oxidation pretreatment at a reaction temperature of 50° C. for 30 min.

### (2) Atomic Layer Deposition of Oxide on the Porous Mesh Separator

A surface of the pretreated porous mesh separator and surfaces inside holes thereof were coated with titanium oxide using atomic layer deposition (ALD) technology; a reaction temperature was 25° C., and a coating was deposited for 20 cycles (0.04 nm were deposited per cycle, and a thickness of the titanium oxide with 20 cycles was about 1 nm), and
specifically including;
step 21, the prepared porous mesh separator was placed into an atomic layer deposition device for atomic layer deposition;
step 22, inert carrier gas was introduced into the atomic layer deposition device and the device was evacuated, an outlet valve of a reaction chamber of the device was adjusted to make the pressure inside the reaction chamber lower than 0.01 atm; and the device was heated to make a deposition temperature being 50° C.; and
since the separator is not resistant to high temperature, the deposition temperature is lowered in the step;
step 23, TiCl₄ was injected into the reaction chamber for 5 s and kept for 60 s; inert carrier gas was introduced to flush out the excess TiCl₄ and byproducts for 30 s: water vapor was injected into the reaction chamber to react with the TiCl₄ adsorbed on a surface of the matrix, and deposit reaction products on a surface of the matrix to be coated or 60 s; and inert carrier gas was introduced again to flush out the unreacted oxygen source vapor and byproducts for 30 s; and
step 24, the step 23 was repeated in cycles, and a desired number of cycles was set to 20 until a thickness of the deposited surface modification material reached 1 nm.

The inert carrier gas was selected from nitrogen, helium, or argon.

The PE lithium battery separator in this embodiment can be replaced by a PP lithium battery separator, the PP lithium battery separator can be either a wet-process separator or a dry-process separator, the PP lithium battery separator is a multilayer base film extruded from PP, and then subjected to high-temperature treatment and stretching to form holes, followed by annealing for dimensional stabilization, a thickness of the separator was about 10-30 microns, with a pore size within a range of 100-200 nm.

The PE lithium battery separator and the PP separator treated by ALD were organic solvent-friendly, which accelerated the infiltration of the organic solvent into the membrane, and improved the affinity with high-polarity electrolyte. When being not treated by ALD, the polyolefin material had low polarity and was inherently hydrophobic.

### (3) Dipping and Coating of the Solid-State Polymer Electrolyte

Preparing the polymer electrolyte solution: PEO and LiDFOB were mixed in a mass ratio of 5:1, and then dissolved in acetonitrile, and a total concentration of the polymer and lithium salt was adjusted to 2 g·mL⁻¹:
the porous mesh separator treated in the step (2) was immersed into the solid-state polymer electrolyte solution, to make the polymer electrolyte infiltrated into pores of the cellulose separator; and
the infiltrated porous mesh separator was taken out, and a distance between a scraper and the porous mesh separator was adjusted to 20-1000 μm, the solution on the porous mesh separator was scraped to form a film; and place the film in a vacuum oven at 60-120° C. for 6-48 h to obtain the solid-state polymer electrolyte separator.

### (4) Heating and Quenching Treatment

The porous mesh separator dipped and coated with the solid-state polymer electrolyte in the step (3) was heated to above 60° C. to make the solid-state polymer electrolyte presents an amorphous state; and instantaneous quenching of the porous mesh separator was performed by liquid nitrogen or other means to ensure that the polymer electrolyte remained in the high-temperature amorphous state even at room temperature.

### Example 3

### (1) Preparation of the Cellulose Separator

The cellulose separator was purchased from EneRol Nanotechnologies, Inc., and was mainly made from cellulose nanofiber, and the separator had a thickness about 10-30 microns, with a pore size within a range of 100-200 nm; and

the cellulose separator was placed in a vacuum chamber for ozone oxidation pretreatment at a reaction temperature of 50° C. for 30 min.

### (2) Atomic Layer Deposition of Oxide on the Cellulose Separator

A surface of the pretreated cellulose separator and surfaces inside holes thereof were coated with lithium oxide using atomic layer deposition (ALD) technology, a reaction temperature was 200° C., and a coating was deposited for 32 cycles (0.045 nm were deposited per cycle, and a thickness of the lithium oxide after 32 cycles was about 1.5 nm), and
specifically including:
step 21, the prepared cellulose separator was placed into an atomic layer deposition device for atomic layer deposition;
step 22, inert carrier gas was introduced into the atomic layer deposition device and the device was evacuated, an outlet valve of a reaction chamber of the device was adjusted to make the pressure inside the reaction chamber lower than 0.01 atm; and the device was heated to make a deposition temperature being 200° C.; and
since the separator is not resistant to high temperature, the deposition temperature is lowered in the step:
   step 23, lithium tert-butoxide (Li(O^{t}Bu)) was injected into the reaction chamber for 5 s and kept for 60 s; inert carrier gas was introduced to flush out the excess Li(O^{t}Bu) and byproducts for 30 s; water was injected into the reaction chamber to react with the Li(O^{t}Bu) adsorbed on a surface of the matrix, and deposit reaction products on a surface of the matrix to be coated or 60 s; and inert carrier gas was introduced again to flush out the unreacted oxygen source vapor and byproducts for 30 s; and
step 24, the step 23 was repeated in cycles, and a desired number of cycles was set to 30 until a thickness of the deposited surface modification material reached 1.5 nm.

The inert carrier gas was selected from nitrogen, helium, or argon.

### (3) Dipping and Coating of the Solid-State Polymer Electrolyte

Preparing the polymer electrolyte solution: PEO and LiDFOB were mixed in a mass ratio of 5:1, and then dissolved in acetonitrile, and a total concentration of the polymer and lithium salt was adjusted to 2 g·mL⁻¹;
the cellulose separator treated in the step (2) was immersed into the solid-state polymer electrolyte solution, to make the polymer electrolyte infiltrated into pores of the cellulose separator; and
the infiltrated cellulose separator was taken out, and a distance between a scraper and the cellulose separator was adjusted to 20-1000 μm, the solution on the cellulose separator was scraped to form a film; and place the film in a vacuum oven at 60-120° C. for 6-48 h to obtain the solid-state polymer electrolyte separator.

### (4) Heating and Quenching Treatment

The cellulose separator dipped and coated with the solid-state polymer electrolyte in the step (3) was heated to above 60° C. to make the solid-state polymer electrolyte presents an amorphous state; and instantaneous quenching of the cellulose separator was performed by liquid nitrogen or other means to ensure that the polymer electrolyte remained in the high-temperature amorphous state even at room temperature.

### Example 4

### (1) Preparation of the Cellulose Separator

The cellulose separator was purchased from EneRol Nanotechnologies, Inc., and was mainly made from cellulose nanofiber, and the separator had a thickness about 10-30 microns, with a pore size within a range of 100-200 nm; and

the cellulose separator was placed in a vacuum chamber for ozone oxidation pretreatment at a reaction temperature of 50° C. for 30 min.

### (2) Atomic Layer Deposition of Oxide on the Cellulose Separator

A surface of the pretreated cellulose separator and surfaces inside holes thereof were coated with oxides of lithium, lanthanum, and zirconium using ALD technology, a reaction temperature was 200° C., with 1 cycle per layer (a total of 23 cycles of the oxides of lithium, lanthanum, and zirconium had a thickness about 3 nm), and
specifically including:
step 21, the prepared cellulose separator was placed into an atomic layer deposition device for atomic layer deposition;
step 22, inert carrier gas was introduced into the atomic layer deposition device and the device was evacuated, an outlet valve of a reaction chamber of the device was adjusted to make the pressure inside the reaction chamber lower than 0.01 atm; and the device was heated to make a deposition temperature being 200° C.; and
since the separator is not resistant to high temperature, the deposition temperature is lowered in the step:
   step 23, lithium tert-butoxide (Li(O^{t}Bu)) was injected into the reaction chamber for 5 s and kept for 60 s; inert carrier gas was introduced to flush out the excess Li(O^{t}Bu) and byproducts for 30 s; water was injected into the reaction chamber to react with the Li(O^{t}Bu) adsorbed on a surface of the matrix, and deposit reaction products on a surface of the matrix to be coated or 60 s; and inert carrier gas was introduced again to flush out the unreacted oxygen source vapor and byproducts for 30 s; and
step 24, tris(cyclopentadienyl) lanthanum (La(Cp)₃) was injected into the reaction chamber for 5 s; inert carrier gas was introduced to flush out the excess La(Cp)₃ and byproducts for 30 s; water was injected into the reaction chamber to react with the La(Cp)₃ adsorbed on a surface of the matrix, and deposit reaction products on a surface of the matrix to be coated or 60 s; and inert carrier gas was introduced again to flush out the unreacted oxygen source vapor and byproducts for 30 s; and
step 25, tetrakis(dimethylamino) zirconium (Zr(NEt₂)₄) was injected into the reaction chamber for 5 s and kept for 60 s; inert carrier gas was introduced to flush out the excess Zr(NEt₂)₄ and byproducts for 30 s; water was injected into the reaction chamber to react with the Zr(NEt₂)₄ adsorbed on a surface of the matrix, and deposit reaction products on a surface of the matrix to be coated or 60 s; and inert carrier gas was introduced again to flush out the unreacted oxygen source vapor and byproducts for 30 s; and
step 26, the steps 23-25 were repeated in cycles, and a desired number of cycles was set to 23 until a thickness of the deposited surface modification material reached 3 nm.

The inert carrier gas was selected from nitrogen, helium, or argon.

### (3) Dipping and Coating of the Solid-State Polymer Electrolyte

Preparing the polymer electrolyte solution: PEO and LiDFOB were mixed in a mass ratio of 5:1, and then dissolved in acetonitrile, and a total concentration of the polymer and lithium salt was adjusted to 2 g·mL⁻¹;
the cellulose separator treated in the step (2) was immersed into the solid-state polymer electrolyte solution, to make the polymer electrolyte infiltrated into pores of the cellulose separator; and
the infiltrated cellulose separator was taken out, and a distance between a scraper and the cellulose separator was adjusted to 20-1000 μm, the solution on the cellulose separator was scraped to form a film; and place the film in a vacuum oven at 60-120° C. for 6-48 h to obtain the solid-state polymer electrolyte separator.

### (4) Heating and Quenching Treatment

The cellulose separator dipped and coated with the solid-state polymer electrolyte in the step (3) was heated to above 60° C. to make the solid-state polymer electrolyte presents an amorphous state; and instantaneous quenching of the cellulose separator was performed by liquid nitrogen or other means to ensure that the polymer electrolyte remained in the high-temperature amorphous state even at room temperature.

### Examples 5-8

A preparation method for the cellulose-based all-solid-state polymer electrolyte separator was the same as that in Example 1, except that thicknesses of the aluminum oxide coated on a surface of the pretreated cellulose separator and surfaces inside holes thereof using ALD technology in the step (2) were 3 nm, 10 nm, 50 nm and 100 nm, respectively.

### Examples 9-11

A preparation method for the cellulose-based all-solid-state polymer electrolyte separator was the same as that in Example 1, except that thicknesses of the oxides of lithium, lanthanum, and zirconium coated on a surface of the pretreated cellulose separator and surfaces inside holes thereof using ALD technology in the step (2) were 10 nm, 50 nm and 100 nm, respectively.

### Comparative Example 1

The differences between this Comparative Example and Examples 1 and 4 are that no oxide was deposited on a surface the pretreated cellulose separator and surfaces inner pores thereof using ALD technology, and no heating and quenching treatment was performed after the solid-state polymer electrolyte separator was obtained. All the other preparation steps were the same.

### Comparative Example 2

The difference between this Comparative Example and Examples 1, 4, 5-11 is that no heating and quenching treatment was performed after the solid-state polymer electrolyte separator was obtained. All the other preparation steps were the same.

Furthermore, in order to verify the advancements of the embodiments of the present disclosure, the solid-state polymer electrolytes prepared in the examples and comparative examples were subjected to the following tests:

1. Battery cycle performance test: the solid-state polymer electrolytes prepared in the examples and comparative examples were assembled into pouch cells with graphite negative electrode sheets and ternary positive electrode sheets under the same conditions, and were then subjected to a 200-cycle charge-discharge test to measure a capacity retention rate (%).

2. Electrolyte stability test: electrochemical windows of the electrolytes in the batteries were measured at 60° C. using a linear sweep voltammetry (LSV) method.

Test results were shown in Tables 1 and 2.

TABLE 1

| | | PEO | PEO | |
|---|---|---|---|---|
| | | composite | composite | PEO composite |
| | | cellulose | cellulose | cellulose |
| | | separator of 3 | separator of 3 | separator of 3 nm |
| | | nm coated | nm coated | coated with |
| | PEO | with oxides of | with oxides of | oxides of lithium, |
| | composite | lithium, | lithium, | lanthanum, and |
| | cellulose | lanthanum, | lanthanum, | zirconium after |
| | separator at | and zirconium | and zirconium | being quenched at |
| | 25° C. | at 25° C. | at 80° C. | 25° C. |
| Ionic | 3.5 × 10⁻⁸ | 5 × 10⁻⁵ | 5 × 10⁻³ | 2 × 10⁻³ |
| conductivity | S/cm | S/cm | S/cm | S/cm |
| Cycle | 50% | 72% | 95% | 90% |
| performance (1 C | | | | |
| capacity | | | | |
| retention rate | | | | |
| after 100 | | | | |
| cycles, %) | | | | |
| Ionic | | 8 × 10⁻⁵ | 8 × 10⁻³ | 7 × 10⁻³ |
| conductivity | | S/cm | S/cm | S/cm |
| Cycle | | 75% | 98% | 94% |
| performance (1 C | | | | |
| capacity | | | | |
| retention rate | | | | |
| after 100 cycles, | | | | |
| Ionic | | 6 × 10⁻⁵ | 6 × 10⁻³ | 5 × 10⁻³ |
| conductivity | | S/cm | S/cm | S/cm |
| Cycle | | 73% | 96% | 92% |
| performance (1 C | | | | |
| capacity | | | | |
| retention rate | | | | |
| after 100 cycles, | | | | |
| %) | | | | |
| Ionic | | 2 × 10⁻⁶ | 3 × 10⁻⁴ | 5 × 10⁻⁴ |
| conductivity | | S/cm | S/cm | S/cm |
| Cycle | | 67% | 90% | 88% |
| performance (1 C | | | | |
| capacity | | | | |
| retention rate | | | | |
| after 100 cycles, | | | | |
| %) | | | | |

TABLE 2

| | | | | PEO |
|---|---|---|---|---|
| | | | | composite |
| | | PEO | PEO | cellulose |
| | | composite | composite | separator of 1 |
| | | cellulose | cellulose | nm coated with |
| | | separator of 1 | separator of 1 | oxides of |
| | | nm coated with | nm coated with | lithium, |
| | PEO | oxides of | oxides of | lanthanum, and |
| | composite | lithium, | lithium, | zirconium after |
| | cellulose | lanthanum, and | lanthanum, and | being |
| | separator | zirconium at | zirconium at | quenched at |
| | at25° C. | 25° C. | 80° C. | 25° C. |
| Ionic | 3.5 × 10⁻⁸ | 2 × 10⁻⁷ | 7 × 10⁻⁴ | 5 × 10⁻⁴ |
| conductivity | S/cm | S/cm | S/cm | S/cm |
| Cycle | 50% | 65% | 90% | 85% |
| performance (1 C | | | | |
| capacity retention | | | | |
| rate after 100 | | | | |
| cycles, %) | | | | |
| Ionic | | 3.5 × 10⁻⁷ | 8 × 10⁻⁴ | 6 × 10⁻⁴ |
| conductivity | | S/cm | S/cm | S/cm |
| Cycle | | 67% | 91% | 86% |
| performance (1 C | | | | |
| capacity retention | | | | |
| rate after 100 | | | | |
| cycles, %) | | | | |
| Ionic | | 6 × 10⁻⁷ | 9 × 10⁻⁴ | 8 × 10⁻⁴ |
| conductivity | | S/cm | S/cm | S/cm |
| Cycle | | 70% | 93% | 89% |
| performance (1 C | | | | |
| capacity retention | | | | |
| rate after 100 | | | | |
| cycles, %) | | | | |
| Ionic | | 5 × 10⁻⁷ | 8 × 10⁻⁴ | 7 × 10⁻⁴ |
| conductivity | | S/cm | S/cm | S/cm |
| Cycle | | 68% | 92% | 87% |
| performance (1 C | | | | |
| capacity retention | | | | |
| rate after 100 | | | | |
| cycles, %) | | | | |
| Ionic | | 1 × 10⁻⁷ | 3 × 10⁻⁴ | 3 × 10⁻⁴ |
| conductivity | | S/cm | S/cm | S/cm |
| Cycle | | 60% | 82% | 80% |
| performance (1 C | | | | |
| capacity retention | | | | |
| rate after 100 | | | | |
| cycles, %) | | | | |

Ionic conductivity indicates that the efficiency of the cellulose separator in conducting lithium ions under given conditions. A higher ionic conductivity means that the lithium ions can pass through the separator more smoothly. At higher charge/discharge rates, the lithium ions need to migrate quickly to support fast charging and discharging. Therefore, the ionic conductivity becomes one of the critical factors limiting the battery performance. In Example 4 and Examples 9-11 of the present disclosure, surfaces of the separator material were coated with material capable of rapidly conducting the lithium ions, and the atomic layer deposition technology was adopted to from a continuous conductive network, which could not only promote rapid migration of the lithium ions in the electrolytes, but also improve the ionic conductivity without damaging the porous structure of the material of the separator or significantly increasing the thickness of the separator.

In Examples 1-3 and Examples 5-8, surfaces of the separator material were coated with material capable of reducing the crystallinity of the polymer matrix at room temperature by using the atomic layer deposition technology, metal oxides could be evenly dispersed in the solid-state polymer electrolytes, which solved the problem that the surfaces of metal oxides adsorbed hydroxyl groups, hindering their uniform dispersion in organic compound, such that the metal oxides were complexed with ether oxygen of PEO, and the crystallinity of PEO was reduced. The reduction in crystallinity usually increased the amorphous region of the polymer, allowing the metal oxides and PEO to form a continuous network interface phase, which could not only promote the rapid migration of lithium ions in the solid-state polymer electrolytes at low activation energy, but also improve the ionic conductivity without damaging the porous structure of the material of the separator or significantly increasing the thickness of the separator.

As shown in FIG. 3, the solid-state polymer electrolyte separator prepared in Example 1 had no characteristic peaks, indicating that the PEO was in an amorphous state, which reduced the crystallinity of PEO and was consistent with the improved ionic conductivity. In contrast, the solid-state polymer electrolyte separators prepared in Comparative Examples 1 and 2 had characteristic peaks.

What is claimed is:

1. A cellulose-based all-solid-state polymer electrolyte separator, comprising a three-dimensional polymer skeleton and a polymer electrolyte: wherein a surface and inner pores of the three-dimensional polymer skeleton are coated with an inorganic oxide nanolayer: the polymer electrolyte comprises a lithium salt and a polymer matrix, the polymer electrolyte is filled in the three-dimensional polymer skeleton coated with the inorganic oxide nanolayer, and is heated to 60° C.-120° C. and vacuum dried to obtain a precursor of the cellulose-based all-solid-state polymer electrolyte separator, the precursor is rapidly frozen and quenched to obtain the cellulose-based all-solid-state polymer electrolyte separator.

2. The cellulose-based all-solid-state polymer electrolyte separator according to claim 1, wherein the three-dimensional polymer skeleton is a three-dimensional interconnected network structure interwoven by a polyethylene (PE) lithium battery separator, or a polypropylene (PP) lithium battery separator, or nanocellulose or multi-dendritic cellulose, with a diameter of the nanocellulose or multi-dendritic cellulose at a nanoscale or a submicron scale: the inorganic oxide nanolayer is selected from one or more of aluminum oxide, titanium oxide, silicon oxide, lithium oxide, and oxides of lithium/lanthanum/zirconium: the lithium salt is selected from at least one of LiPF₆, LiBF₄, lithium perfluoroalkyl sulfonimide lithium salts, lithium borate complexes, lithium phosphate complexes, and lithium aluminate; and the polymer matrix is selected from at least one of polyethylene oxide or modified substances thereof, polyacrylonitrile or modified substances thereof, polymethyl methacrylate or modified substances thereof, poly(ethylene carbonate) or modified substances thereof, polyvinylidene fluoride or modified substances thereof, polycarbonate or modified substances thereof, polysiloxane or modified substances thereof, or succinonitrile or modified substances thereof.

3. The cellulose-based all-solid-state polymer electrolyte separator according to claim 1, wherein the three-dimensional interconnected network structure interwoven by a PE lithium battery separator, or a PP lithium battery separator, or nanocellulose or multi-dendritic cellulose has a thickness of 10-30 microns, with a pore size within a range of 100-200 nm.

4. A preparation method for the cellulose-based all-solid-state polymer electrolyte separator according to claim 1, comprising the following steps:
S1, preparing the three-dimensional polymer skeleton;
S2, depositing the inorganic oxide nanolayer on the three-dimensional polymer skeleton using an atomic layer deposition technology:
S3, filling the polymer electrolyte in the three-dimensional polymer skeleton coated with the inorganic oxide nanolayer, and heating for curing; and
S4, performing a quenching treatment.

5. The preparation method according to claim 4, wherein the three-dimensional polymer skeleton in the S1 is subjected to a surface treatment, the surface treatment comprises pre-treatment by ozone oxidation under vacuum or electron irradiation, the three-dimensional polymer skeleton mainly consists of nanocellulose, or a PE lithium battery separator, or a PP lithium battery separator, and the PE lithium battery separator or the PP lithium battery separator has a thickness of 10-30 microns, with a pore size within a range of 100-300 nm.

6. The preparation method according to claim 5, wherein the S2 further comprises:
S21, placing the three-dimensional polymer skeleton in an atomic layer deposition device:
S22, introducing an inert carrier gas into the atomic layer deposition device and evacuating the atomic layer deposition device, adjusting to make a pressure inside a reaction chamber lower than 0.01 atm, and to make a temperature inside the reaction chamber up to 25-200° C.; and
S23, repeatedly and alternately injecting a first gas-phase precursor and an oxygen source vapor into the reaction chamber, such that the first gas-phase precursor and the oxygen source vapor react to form an inorganic oxide, wherein the inorganic oxide is deposited layer by layer on the surface and the inner pores of the three-dimensional polymer skeleton, and a residual gas in the reaction chamber is replaced with the inert carrier gas.

7. The preparation method according to claim 6, wherein the first gas-phase precursor is selected from one or a mixture of volatile silicon ions, metal alkylamino salts, metal organic compounds, halides, alkoxides, or metal β-diketone complexes, metal ions in the metal alkylamino salts, the metal organic compounds, the halides, the alkoxides, or the metal β-diketone complexes are aluminum, titanium, lithium, lanthanum, or zirconium ions, and the inert carrier gas is selected from nitrogen, helium, or argon; and the oxygen source vapor is selected from one of deionized water, hydrogen peroxide, oxygen, ozone, or atomic oxygen.

8. The preparation method according to claim 6, wherein the S3 further comprises: immersing the three-dimensional polymer skeleton treated in the S2 into a polymer electrolyte solution, scraping the polymer electrolyte solution on the three-dimensional polymer skeleton evenly, and then placing in a vacuum oven for drying to obtain the precursor of the cellulose-based all-solid-state polymer electrolyte separator.

9. The preparation method according to claim 8, wherein a mass ratio of the polymer matrix to the lithium salt in the polymer electrolyte solution is (20:1)-(1:1), and a polymer concentration in a solvent is 0.1-10 g·mL⁻¹; and the solvent of the polymer electrolyte solution is selected from one or more of N-dimethylformamide, acetonitrile, N-methylpyrrolidone, dimethyl sulfoxide, or dichloromethane.

10. A solid-state battery, comprising the cellulose-based all-solid-state polymer electrolyte separator according to claim 1.

11. A solid-state battery, comprising the cellulose-based all-solid-state polymer electrolyte separator prepared by the preparation method according to claim 4.
